(19) United States
(12) Patent Application Publication
(10) Pub. No.: US 2025/0345832 A1
(43) Pub. Date: Nov. 13, 2025

(54) ENCLOSED AUTOMATED CLEANING SYSTEM FOR INTERNAL CAVITIES OF PRESSURE INSTRUMENTS

(71) Applicant: King Nutronics Corporation, Woodland Hills, CA (US)

(72) Inventors: Amir Gnessin, Woodland Hills, CA (US); Robert T. Welther, Woodland Hills, CA (US); Dustin Knowlton, Woodland Hills, CA (US); Michael Kruger, Woodland Hills, CA (US)

(21) Appl. No.: 19/205,833

(22) Filed: May 12, 2025

Related U.S. Application Data
(60) Provisional application No. 63/646,603, filed on May 13, 2024.

(51) Int. Cl. B08B 9/035

(52) U.S. Cl. CPC B08B 9/035; B08B 2209/032

(57) ABSTRACT

An enclosed automated cleaning system for internal cavities of pressure instruments is disclosed. The new computer-controlled fluid flow system enables various cleaning fluids to clean the internal cavities of pressure instruments. Various pressure instruments, including complex shapes such as Bourdon Tube gauges, are accommodated. The system can utilize a computerized cleaning cycle selection and can use nonflammable, non-ozone-depleting solvents while generating minimal waste fluids. The used solvents can be continuously or intermittently recycled to be used in the next cleaning cycles. A servo-controlled agitation system allows for the filling, evacuation, and drying of solvents to clean general-purpose pressure gauges and maintain an oxygen-clean cleanliness level. In some embodiments, the system can include automated or manual inspection ports for inspection of the spent and/or distilled solvent for quality control.

### CROSS REFERENCE

This application claims priority to U.S. Provisional Patent Application No. 63/646,603, filed May 13, 2024, the entire contents of which are incorporated herein by reference in their entireties. Any and all applications for which a foreign or domestic priority claim is identified in the Application Data Sheet as filed with the present application are hereby incorporated by reference under 37 CFR 1.57.

### BACKGROUND

Pressure measurement instruments can include pressure gauges and pressure transducers. Pressure gauges indicate pressure level by a mechanical pointer and a graduated face plate. Pressure transducers convert pressure levels to electric signals.

For many types of pressure instruments, the measuring device must be in contact with the measured fluid, whether gas or liquid. The fluid therefore enters a blind cavity in the device and the pressure deforms a mechanical component that causes movement of a dial or deflection of an electrical sensor. Since the instrument is usually connected to an active fluid flow, impurities in the main system may contaminate the instrument. For example, engine oil might introduce hydrocarbon sludge, drinking water may leave mineral sediments, and medical applications may contaminate the instruments with biohazards. Contaminates such as oil, metal chips, and solder flux may also be introduced during the manufacturing process of the instruments.

A common pressure gauge is the Bourdon-Tube type. It includes a radially bent tube that is closed at one end. The other end of the tube is connected to the measure fluid, usually by a threaded port. The Bourdon-Tube type gauge is manufactured in large quantities and provides long term consistent accuracy performance across a large range of pressure levels from vacuum to thousands of PSI.

### SUMMARY OF CERTAIN FEATURES AND ASPECTS

Pressure gauges must be cleaned periodically. Excessive sediment in the Bourdon-tube may limit its ability to bend and therefore may affect the indicating accuracy of the gauge. Fluid residue that is left in the gauge may contaminate calibration equipment when the gauge is sent to the maintenance lab for periodic calibration. The most critical need for cleanliness is when the gauge is used in oxygen service. Even trace amounts of contaminants, hydrocarbons in particular, can pose significant hazards in oxygen-rich environments, leading to potential fires or explosions. A gauge cleaned for oxygen service is typically sealed in vacuum after cleaning and can be opened again in a clean room environment. The cleanliness level is typically measured by introducing one or more iterations of a rinsing fluid into the gauge and inspecting the final rinsing fluid. Typical oxygen cleaning procedures require cleanliness levels of not more than 5 PPM hydrocarbons left in the fluid.

A common method for gauge cleaning involves a vacuum pump for evacuation of fluids from the cavity, a selector valve, and a solvent source. First the selector valve connects the gauge to the vacuum source and then the operator switches the valve to the solvent line. The fresh solvent flows into the cavity until its pressure equalizes with ambient pressure. The gauge's port is connected to a flexible hose and the operator manipulates the orientation of the gauge's housing to promote filling and evacuation of fluids. The process is repeated several times until the drained solvent seems clean. The above system can be easily constructed in the lab or can be purchased as a packaged system from King Nutronics Corporation and is known as the “Model 3646 instruments cleaning system”.

Historically, solvents like chlorofluorocarbons (CFCs), such as Freon 113, and hydrochlorofluorocarbons (HCFCs) were the favored cleaning solution due to their effectiveness in cleaning gauges without corroding or contaminating the sensitive components. They were cheap, plentiful, and evaporated away quickly which meant drying was not an issue. However, their detrimental impact on the ozone layer and contribution to global warming prompted bans on their use and the search for more environmentally friendly alternatives.

A newer generation of cleaning solvents, such as Honeywell's Solstice® solvent, have excellent cleaning and environmental properties. They have favorable toxicity profiles, low global warming potential, and excellent compatibility with many materials. A primary problem with such solvents is that of a low boiling point; many exist as gas at room temperature. As a result, the traditional method of using vacuum to vacate and then fill a bourdon tube gauge with liquid solvent as described above will not work. The solvents quickly expand into vapor under vacuum and as such only gas is deposited into the Bourdon tube cavity, which is insufficient for cleaning. A secondary problem exists in that today's generation of cleaning solvents are costly and of limited supply. The amount of solvent needed to clean a gauge can cost more than the gauge itself and is often considered cheaper to replace the gauge than to clean it.

Disclosed herein are systems and methods for systems to utilize newer, more chemically volatile solvents to clean measurement equipment, and related systems, and systems and methods for the distillation of such solvents. The following description will concentrate on the cleaning of Bourdon-Tube type gauges as an illustrative example, however the technology is also applicable to other types of instruments, including those with blind cavities, pressure transducers, and otherwise. In various implementations, the systems and methods can be used to provide an oxygen-clean cleanliness level.

The technology can maintain the solvent in a liquid state by controlling pressure and temperature. For example, in certain embodiments, the solvent can be pressurized to at least about 40 psi and/or can be cooled to less than or equal to about −20° F. The technology can include vacating the internal volume of a gauge by way of vacuum. For example, the air inside a gauge or other equipment to be cleaned can be removed via vacuum and then the pressure and temperature regulated volume of liquid solvent can be quickly introduced to the gauge. During this process, some of the liquid solvent may vaporize but can be re-liquified upon stabilization of the pressure and temperature of the fluid. Cleaning of the equipment, which may include agitation, can then occur before removal of the solvent, such as by a vacuum pump.

Due to the relative volatility of the newer chemical solvents, proper regulation of pressure, temperature, and vacuum can be crucial in safely and/or thoroughly cleaning the equipment, particularly in low pressure and high accuracy gauges. A low-pressure gauge may be damaged or destroyed by the high pressure required to keep some solvents solvent in a liquid state when at room temperature. Accordingly, as described herein according to at least some embodiments, the instrument cleaning system can advantageously lower the solvent temperature to the point where the additional pressure is less than that of safe operation of the gauge, allowing for use of these newer solvents without damaging or destroying the equipment. A human machine interface (HMI), such as a touch screen, may be used to select and run different profiles depending on the equipment to be cleaned, the type of solvent used for the cleaning system, the purity of the solvent used, and/or any other features or elements to be considered, as desired or required for a particular cleaning process.

The change to these newer chemical solvents may bring higher costs, as the solvent itself can generally be more expensive than prior, more harmful solvents. Therefore, at least according to some embodiments of the instrument cleaning system disclosed herein, the system can advantageously include a distillation system to recycle at least a portion of the spent solvent.

Various cleaning methods and steps can be utilized to incrementally increase the purity of spent solvent for re-use in later cleaning methods, both decreasing the waste generated by the system as well as increasing the overall cost effectiveness of using these less harmful solvents. Contaminated solvent can be passed through a variety of cleaning apparatus, such as filters to remove large particulates extracted from the cleaned equipment, a boiler and condenser to recover clean solvent and re-fed back into the system for use in further cleaning operations, and any other purification system, as desired or required.

Due to the recycling of the solvent, the instrument cleaning system disclosed herein may require only periodic replenishment of solvent and dumping of waste products, cutting down significantly on the overall volume of solvent needed to clean each gauge, while also preserving the costly and precious solvent.

The present technology can include any of the features, steps, or elements disclosed in U.S. Pat. No. 11,446,716, the entirety of which is incorporated by reference herein.

In some aspects, the techniques described herein relate to a system for cleaning internals of an apparatus using a solvent at a controlled temperature and pressure, the system including: a supply tank configured to contain a solvent in liquid form; a cleaning unit configured to receive an apparatus for a cleaning procedure, wherein the system regulates a temperature and a pressure of the solvent such that the solvent is provided in liquid form by a conduit to an internal portion of the apparatus; an agitation unit within the cleaning unit, the agitation unit configured to agitate the solvent within the internal portion of the apparatus to remove a contaminant; and a distillation system configured to distill the spent solvent drawn from the agitation unit for storage in a distilled solvent tank; wherein, before the cleaning procedure, a vacuum is drawn in at least a portion of the system by one or more pumps, and wherein the distilled solvent is suitable for use by the cleaning unit for the cleaning procedure.

In some aspects, the techniques described herein relate to a system, wherein the supply tank further includes a pressure source, the pressure source configured to maintain the solvent in liquid form when providing the solvent to the cleaning unit.

In some aspects, the techniques described herein relate to a system, wherein the pressure source maintains the solvent at approximately 30 pounds per square inch gauge before providing the solvent to the cleaning unit.

In some aspects, the techniques described herein relate to a system, wherein the pressure source includes a membrane accumulator, wherein the solvent is positioned on a first side of the membrane; wherein a pressurized gas is positioned on a second side of the membrane; wherein the first side and the second side are fluidically separated by the membrane; and wherein pressurizing the pressurized gas exerts a force on the membrane to pressurize the solvent in fluidic communication with the supply tank.

In some aspects, the techniques described herein relate to a system, wherein the pressure source includes a piston accumulator, wherein the solvent is positioned on a first side of a piston crown; wherein a pressurized gas is positioned on a second side of the piston crown; wherein the first side and the second side are fluidically separated by the piston crown; and wherein pressurizing the pressurized gas exerts a force on the piston crown to pressurize the solvent in fluidic communication with the supply tank.

In some aspects, the techniques described herein relate to a system, wherein the pressure source includes a bladder accumulator filled with a pressurized gas, wherein filling the bladder accumulator with the pressurized gas in turn pressurizes the solvent in fluidic communication with the supply tank.

In some aspects, the techniques described herein relate to a system, wherein a sensor within the cleaning unit measures a pressure and a temperature of the solvent within the cleaning unit, wherein the pressure source is configured to pressurize the supply tank if the solvent is not in liquid form at the measured pressure and measured temperature to convert the solvent to liquid form.

In some aspects, the techniques described herein relate to a system, wherein the system is configured to receive an input from an operator defining a safe pressure for the apparatus, wherein the cleaning unit further includes a sensor configured to measure a pressure and a temperature of the solvent within the cleaning unit, and wherein the cleaning unit does not pressurize the solvent to or above the safe pressure for the apparatus while maintaining at least a portion of the solvent in liquid form by cooling the solvent.

In some aspects, the techniques described herein relate to a system, wherein if the safe pressure is approximately 5 pounds per square inch and the solvent is cooled to approximately 0° Celsius.

In some aspects, the techniques described herein relate to a system, wherein the agitation unit includes a pneumatic agitator, the pneumatic agitator including a piston configured to move within a piston housing, wherein the pneumatic agitator is configured to be filled with the solvent during the cleaning procedure, and wherein a change in the volume of the pneumatic agitator induces movement in the solvent within the internal portion of the apparatus.

In some aspects, the techniques described herein relate to a system, wherein the pneumatic agitator further includes a pressure sensor, wherein operation of the pneumatic agitator is controlled based on readings from the pressure sensor.

In some aspects, the techniques described herein relate to a system, wherein the pneumatic agitator is configured to fluctuate the pressure within the cleaning unit.

In some aspects, the techniques described herein relate to a system, wherein fluctuating the pressure forces at least a portion of the solvent into a gaseous state.

In some aspects, the techniques described herein relate to a system, wherein the agitation unit includes a mechanical agitator configured to manipulate the apparatus.

In some aspects, the techniques described herein relate to a system, wherein the mechanical agitator manipulates the apparatus by rotating, vibrating, translating, or otherwise moving the apparatus relative to the system to induce movement of the solvent within the internal portion of the apparatus.

In some aspects, the techniques described herein relate to a system, further including a filter positioned between the cleaning unit and the distillation system, the filter configured to collect solid particulates as the spent solvent moves toward the distillation system.

In some aspects, the techniques described herein relate to a system, wherein the filter is configured to be removable from the system.

In some aspects, the techniques described herein relate to a system, wherein the distillation system includes: a distillation tower configured to receive and separate the spent solvent into a waste product and the distilled solvent; and a distillation tower configured to at least temporarily contain the distilled solvent; wherein the distillation system removes contaminants from the spent solvent to create the distilled solvent.

In some aspects, the techniques described herein relate to a system, further including a heating element configured to heat the spent solvent before the distillation tower to a temperature suitable for flash distillation.

In some aspects, the techniques described herein relate to a system, wherein the temperature suitable for flash distillation is approximately 20° Celsius.

In some aspects, the techniques described herein relate to a system, further including a nozzle at an inlet to the distillation tower, wherein the spent solvent is misted and/or otherwise spread within the distillation tower, wherein misting the spent solvent increases the efficacy of flash distillation in the distillation tower.

In some aspects, the techniques described herein relate to a system, wherein the distillation tower maintains an internal pressure of approximately no more than 1 atmosphere, and wherein the distillation tower is configured to heat the spent solvent to a vaporizing temperature when at the internal pressure.

In some aspects, the techniques described herein relate to a system, wherein the internal pressure of a distillation tower is below 1 atmosphere.

In some aspects, the techniques described herein relate to a system, wherein the distillation tower is configured such that the waste product is removable by a waste pump.

In some aspects, the techniques described herein relate to a system, wherein the distillation tower is configured such that the waste product is removable by a waste hatch.

In some aspects, the techniques described herein relate to a system, wherein the distillation tower is configured to reflux at least a portion of the distilled solvent to the distillation tower, wherein refluxing to the distillation tower increases efficacy of the distillation system.

In some aspects, the techniques described herein relate to a system, wherein the distillation system further includes a condenser configured to condense the distilled solvent after the distillation tower.

In some aspects, the techniques described herein relate to a system, wherein the condenser cools the distilled solvent to at least approximately 10° Celsius.

In some aspects, the techniques described herein relate to a system, wherein the distilled solvent tank is configured to store the distilled solvent, wherein a distillation pump pressurizes the distilled solvent tank to a storage pressure, wherein the storage pressure is sufficient to maintain the distilled solvent as a liquid when at room temperature.

In some aspects, the techniques described herein relate to a system, further including a cleaning sampling valve positioned between the cleaning unit and the distillation system, the cleaning sampling valve configured to provide a sample of the spent solvent to a user for inspection to determine if further cleaning procedures are required.

In some aspects, the techniques described herein relate to a system, further including a distillation sampling valve positioned between the distillation system and the distilled solvent tank, the distillation sampling valve configured to provide a sample of the distilled solvent to a user for inspection to determine if further distillation is required.

In some aspects, the techniques described herein relate to a pressure gauge cleaning system for use with a solvent having a boiling point of less than 70° F. at 1 atmosphere, the system including: a supply tank configured to hold a volume of the solvent and to maintain the solvent in liquid form; a cleaning unit configured to connect to a pressure gauge for cleaning, the cleaning unit in communication with the supply tank such that the solvent in liquid form can flow from the supply tank into the pressure gauge; an agitation unit configured to agitate the liquid solvent in the pressure gauge; a vacuum pump configured to withdraw the liquid solvent from the pressure gauge; a distillation system configured to clean the spent solvent; and a recirculation pump configured to provide the cleaned solvent to the supply tank.

In some aspects, the techniques described herein relate to a method of cleaning a pressure gauge using a solvent that exists in gas form at room temperature and ambient pressure, the method including: pressurizing and cooling the solvent such that the solvent is in liquid form in a supply tank; providing the liquid solvent to a pressure gauge to be cleaned; agitating the pressure gauge and/or the liquid solvent in the pressure gauge; withdrawing the used solvent from the pressure gauge; cleaning the used solvent; providing the cleaned solvent to the supply tank; and repeating any prior steps as needed until the pressure gauge is cleaned.

According to some embodiments, the techniques described herein relate to a method of cleaning the internals of a sensing tool (e.g., pressure measurement instrument) using a solvent which can be volatile at ambient temperature and pressure. The method can include creating a vacuum within an instrument cleaning system, drawing fluid solvent into a cleaning unit which is fluidically connected to the internals of the apparatus to be cleaned, agitating the fluid solvent within the apparatus, such as through the use of an agitation unit, draining spent solvent from the apparatus, and/or distilling the spent solvent for re-use.

In some embodiments, this method can include inspecting the spent solvent to determine if further cleaning procedures are required, by draining at least a portion of the spent solvent to a sampling area for inspection.

In some embodiments, this method can include inspecting the distilled solvent for purity to determine if further distillation is required, by draining at least a portion of the distilled solvent to a sampling area for inspection.

In some embodiments, this method can include performing a supplementary cleaning procedure using at least a part of the distilled solvent from a prior cleaning procedure.

In some embodiments, this method can include loading the instrument cleaning system with pure solvent to be stored at a temperature and pressure sufficient to keep the solvent in liquid form.

In some embodiments, drawing fluid solvent into the cleaning unit includes a combination of vacuum within the cleaning unit as well as a positive pressure applied by a solvent supply tank storing the liquid solvent.

In some embodiments, the method can include cooling the solvent within the cleaning unit to maintain the solvent in liquid form.

In some embodiments, agitating the fluid solvent within the apparatus comprises using a pneumatic agitator to induce fluid flow within the components of the apparatus.

For purposes of summarizing the disclosure, certain aspects, advantages and features of the inventions are described herein. Not necessarily any or all such advantages are achieved in accordance with any particular embodiment of the inventions disclosed herein. No aspects of this disclosure are essential or indispensable. Neither this summary nor the following detailed descriptions purport to define or limit the scope of the inventive subject matter.

### BRIEF DESCRIPTION OF THE DRAWINGS

Various features of the present disclosure will become more fully apparent from the description above and as follows, taken in conjunction with the accompanying drawings.

FIG. 1 schematically depicts an example embodiment of an instrument cleaning system as described herein.

FIGS. 2A-2C depict an example method of using an embodiment of the instrument cleaning system described herein.

### DETAILED DESCRIPTION CERTAIN EMBODIMENTS

Described herein are example systems and methods teaching a cleaning system capable of efficiently using volatile solvents for cleaning delicate scientific equipment, and a distillation method to recapture this solvent for re-use. Various valves, pumps, sensors, and other components are described throughout this application. One of ordinary skill in the art will appreciate that it may be possible to design a system with fewer or more of these components to achieve a similar effect. Therefore, disclosure of any specific valve or other component within this application should not be taken as a mandatory inclusion to create a viable system capable of performing the novel concepts disclosed herein.

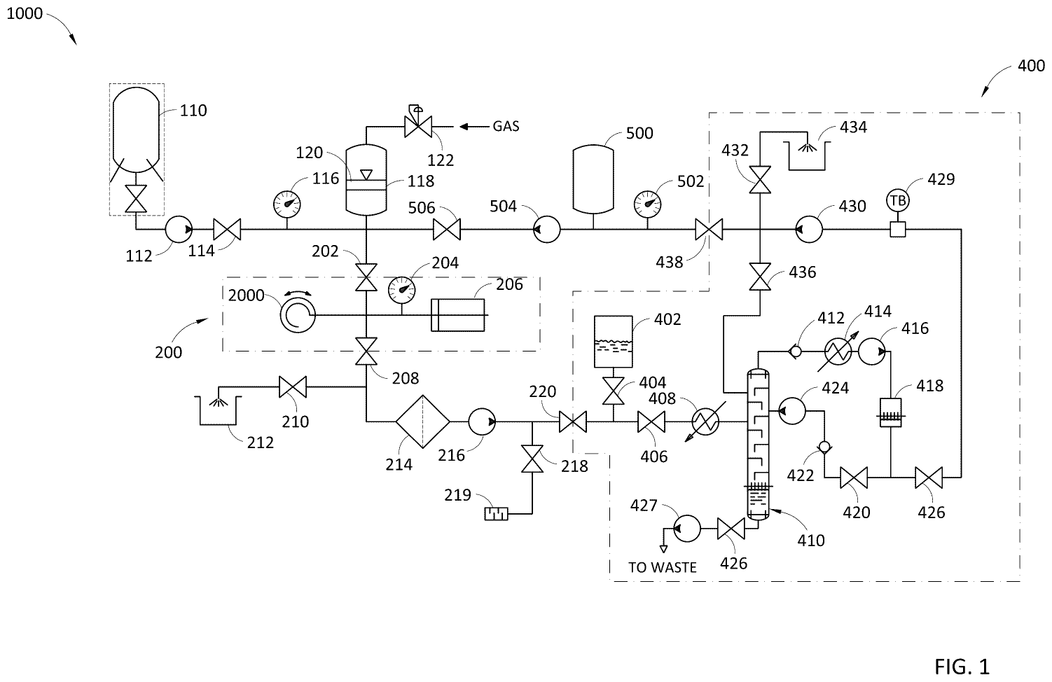

FIG. 1 illustrates a diagram of an example instrument (e.g., a pressure gauge) cleaning system 1000 that implements aspects of the present technology. The cleaning system 1000 can regulate the pressure and/or temperature of a cleaning fluid (e.g. solvent). The cleaning system 1000 can vacate the internal volume of a gauge, such as by vacuum. In some embodiments, the solvent used within the instrument cleaning system 1000 can have a boiling point of less than about 70° F. at 1 atmosphere, which can add to the difficulty of using it in a cleaning procedure.

In certain implementations, the system 1000 can clean a gauge to an oxygen-clean cleanliness level (e.g., less than or equal to about: 11 mg/m², 33 mg/m², 66 mg/m², 220 mg/m², or otherwise, such as when measured according to ASTM G93-03).

The instrument cleaning system 1000 can include a cleaning unit 200 to accept an apparatus 2000 (e.g., pressure gauge, Bourdon tube, etc.) to be cleaned. The system 1000 can include a distillation system 400 (e.g., distillation unit, distiller, distillery, etc.) to refine the spent solvent for reuse during a later cleaning procedure. The instrument cleaning system 1000 can be designed such that the path the solvent travels through the instrument cleaning system 1000 forms a closed loop and/or is another closed system (e.g., not open to the ambient environment), thereby reducing potential losses.

The instrument cleaning system 1000 can utilize a combination of vacuum sources and positive pressure to maneuver a solvent within the apparatus 2000 while maintaining the solvent in a fluid, semi-fluid, or liquid state.

The instrument cleaning system 1000 can include, according to at least some embodiments, a solvent supply tank 118 configured to supply a solvent in liquid form to a cleaning unit 200. A vacuum can be formed within the cleaning unit 200, such as by a vacuum pump 216, such that upon opening of a valve 202, solvent from the solvent supply tank 118 is drawn into the cleaning unit 200. Positive pressure from the solvent supply tank 118 or other components (e.g., a pressurization tank, a pressure source) can maintain the solvent in its liquid form during such steps.

The apparatus 2000 can be connected to a portion of the cleaning unit 200 such that an agitation unit 206 can circulate flow of the solvent within internal components of the apparatus 2000. This solvent can dislodge particulates stuck within the apparatus 2000 and/or otherwise clean the apparatus 2000. In certain implementations the system 2000 can clean the apparatus 2000 of contaminants, including but not limited to dust, particulates, solder or other components dislodged or misplaced during manufacturing of the apparatus 2000, grease, flux, and/or contaminants which could affect the accuracy and/or integrity of the apparatus 2000.

Spent (e.g., used) solvent can be drawn from the apparatus 2000 by a vacuum pump 216. In some embodiments, this vacuum pump 216 can be a fixed displacement pump. This spent solvent can be examined by an operator to determine if further cleaning steps are required. If required, the cleaning step can be repeated. After cleaning is completed, the apparatus 2000 can be removed from the instrument cleaning system 1000.

In various implementations, spent solvent can be recycled by a distillation system 400. The distillation system 400 can remove dissolved particles within the solvent to separate the solvent from any grease or dissolvable materials picked up during the cleaning procedure. The distillation system 400 can include a heater 408 to pre-heat the spent solvent before entering a distillation tower 410, where the spent solvent can be vaporized. According to at least some embodiments, at least a portion of this distilled solvent can be re-fed into the distillation tower as reflux to increase the efficacy of the distillation tower 410. Any waste can be removed from the distillation tower 410 via a valve 426 or other method as desired or required, based on the type and quantity of the waste produced.

The distilled solvent can be examined by an operator to determine if further distillation steps are required. If required, the solvent can be recirculated through the distillation tower 410 for further cleaning. This can be done with or without needing to remove the waste from the distillation tower 410. Once the distilled solvent is sufficiently cleaned, it can be stored in a distilled solvent tank 500 for use in cleaning another apparatus.

### Loading of Distillation Fluid

The instrument cleaning system 1000 can receive a new supply of solvent from a solvent replenishment tank 110. The contents of the solvent replenishment tank 110 can be removed by a pump 112 to direct the fluid into the solvent supply tank 118, where the solvent will be drawn from during the cleaning procedure. The solvent within the solvent replenishment tank 110 may be in a pressurized state, as the solvent within may be gaseous at an ambient temperature and pressure. The solvent within the solvent replenishment tank 110 may be maintained in a liquid state.

Fluid may be drawn from the solvent replenishment tank 110, such as with one or a combination of a vacuum and by positive pressure of a pump 112. For example, a vacuum can be drawn by opening vacuum valve 218, closing valves 506, 210, 114, and 220, and activating vacuum pump 216. Once a sufficient vacuum is drawn by evacuating air from the system out vacuum valve 218 and a muffler 219 to ambient air, valves 202 and 218 can be closed and vacuum pump 216 can be deactivated.

Fluid can be drawn from the solvent replenishment tank 110 by opening valve 114 to direct the solvent to fill solvent supply tank 118. In order to further pressurize the solvent drawn from solvent replenishment tank 110 into the solvent supply tank 118, pump 112 can be activated. Thus, the fluid within the solvent supply tank 118 can be pressurized to a higher pressure state than it was pressurized to within the solvent replenishment tank 110.

Fluid within the solvent supply tank 118 can be stored in a pressurized and/or liquid state as described above. The solvent supply tank 118 can be an insulated, chilled, and/or pressurized tank configured to store the solvent for an extended period of time. The solvent supply tank 118 can be configured such that it stores the solvent at a pressure sufficient to maintain the fluid in liquid form, even when at room temperature.

Control of the temperature and pressure of the solvent supply tank 118 may be regulated by a control system of the instrument cleaning system 1000. Information collected by sensors 116 in fluid communication with the solvent supply tank 118 can be displayed on a user interface for the system and/or provided to a control system which automatically regulates the temperature and pressure of the solvent supply tank 118 to keep the solvent in liquid form. In some embodiments, the sensors 116 can further include visual sensors, such as a window or sight glass into the conduits leading to and/or in fluid communication with the solvent supply tank 118. The sensors 116 can include volumetric readings.

In some embodiments, the temperature and pressure control of the solvent supply tank 118 is performed considering the apparatus 2000 to be cleaned in a cleaning step. For example and without limitation, in embodiments where the apparatus 2000 would be damaged or destroyed by high pressures, the solvent supply tank 118 may store the solvent at a lower pressure and correspondingly cool the solvent to a lower temperature to maintain it in liquid form. Conversely, if the apparatus 2000 can withstand (e.g., would not be damaged by) higher pressures, the solvent supply tank 118 may store the solvent at a relatively higher pressure and a relatively warmer state, while still maintaining the solvent in liquid form. Variation of the potential storage temperatures and pressures can be predetermined based on the type of apparatus 2000 to be cleaned. The instrument cleaning system 1000 can be configured to automatically provide these storage instructions based on the apparatus to be cleaned. This decision can be made by a user interface, such as by selecting an apparatus to be cleaned from a touch screen.

In some embodiments, the solvent supply tank 118 can be pressurized by various pressure sources to maintain the solvent in liquid form. In some embodiments, the pressure source can maintain the solvent at approximately 30 pounds per square inch gauge to keep the solvent in liquid form. In some embodiments, the pressure source can include an accumulator integrated into the solvent supply tank 118 which reduces the volume within the container after loaded by the solvent replenishment tank 110. The accumulator 120 can be, for example and without limitation, a piston accumulator, a membrane accumulator, a bladder accumulator, or any other form of hydraulic accumulator as desired or required.

The accumulator 120 can facilitate pressurizing the contents of the solvent supply tank 118. This can be advantageous when priming the cleaning unit 200 with solvent, as the process of filling the cleaning unit 200 with solvent can reduce the pressure in the solvent sufficiently to change at least a portion of the solvent into a gas. Therefore, by applying further pressure through the accumulator 120, the solvent may remain in gaseous form even during rapid pressure drops when loading the cleaning unit 200.

In some embodiments, the accumulator 120 can be a membrane accumulator, which includes a membrane spanning the width of the solvent supply tank 118. The membrane can divide the tank into a first side which stores the solvent and a second side which stores the pressurizing gas (e.g., pressurized gas, pressure source, etc.). The pressurized gas can be supplied by a tank valve 122 which may be operatively connected and/or controlled by the control system. Gas can be provided or evacuated to fill the solvent supply tank 118 based on the pressure read by the sensors 116 or other sensors connected to the control system.

In some embodiments, the accumulator 120 can be a piston accumulator, which includes a sliding piston spanning the width of the solvent supply tank 118. The piston crown can divide the tank into a first side which stores the solvent and a second side which stores the pressurizing gas. The pressurized gas can be supplied by a tank valve 122 which may be operatively connected and/or controlled by the control system. Gas can be provided or evacuated to fill the solvent supply tank 118 based on the pressure read by the sensors 116 or other sensors connected to the control system. Filling of the tank can displace the piston crown (e.g., piston head, piston, etc.) within the solvent supply tank 118, which can apply pressure to the solvent. Use of a piston accumulator could be beneficial in situations where there are high flow rates, extreme temperatures, high compression ratios, and durability in resisting external forces.

In some embodiments, the accumulator 120 can be a bladder accumulator, which includes a bladder positioned to occupy at least a portion of the volume of the solvent supply tank 118. The bladder can be connected to an inlet portion to be in fluidic communication with the tank valve 122, such that the solvent cannot escape the solvent supply tank 118 by the tank valve 122. Gas can be provided or evacuated to fill the bladder within the solvent supply tank 118 based on the pressure read by the sensors 116 or other sensors connected to the control system. Filling of the bladder can displace the solvent within the tank, compressing it to force the solvent into a fluid form. Use of a bladder accumulator could be beneficial in reducing potential contamination of the solvent with the compressing gas, and more immediate responsiveness.

In some embodiments, the tank valve 122 can provide a pressurizing gas or fluid to the solvent supply tank 118. In some embodiments, this can provide a gas, such as nitrogen gas, to the accumulator 120 to pressurize the solvent. In some embodiments, the gas can be clean and dry to prevent possibilities of contamination of the solvent within the solvent supply tank 118. In some embodiment, pressurized ambient air can be provided to the accumulator 120. In some embodiments using ambient air, the instrument cleaning system 1000 may be operated within a cleanroom or sterile environment to prevent contamination of the solvent within the solvent supply tank 118.

### Cleaning Unit

Once solvent is loaded and pressurized for use in a cleaning procedure, a valve 202 can be opened to draw the solvent into the valve 202 by the combination of negative pressure due to the vacuum within the cleaning unit 200 in combination with the positive pressure exerted by the accumulator 120. The solvent can thus fill the volume defined by valves 208, 114, 506, and the solvent supply tank 118.

In some embodiments, this movement of fluid can result in at least a portion of the solvent to convert to a gaseous state due to the increase in volume by opening the valve 202. In order to address (e.g., compensate for) this change of state, the sensors 116 and cleaning sensor 204 within the cleaning unit 200 can read the status (e.g., state, temperature, pressure, density, etc.) of the solvent and determine how much of the fluid has changed to a gas. This measured information can be relayed to the accumulator 120, which can exert further pressure onto the solvent within the solvent supply tank 118, forcing the solvent back into liquid form.

In some embodiments, the accumulator 120 applies sufficient pressure to the solvent within the solvent supply tank 118 such that further changes to the pressure exerted by the accumulator 120 upon opening of valve 202 is not necessary to maintain the solvent in liquid form. In some embodiments, the pressure exerted by the accumulator 120 and the temperature of the solvent within the solvent supply tank 118 are set such that simply waiting for the system to reach a steady state is sufficient to have all or substantially all of solvent in the cleaning unit to be in liquid form.

In some embodiments, valve 202 can be a flow control valve configured to regulate the speed at which the solvent flows into the cleaning unit 200. Regulating the flow rate into the cleaning unit 200 can limit the amount of solvent that converts to a gaseous state. By lowering the speed at which fluid enders the cleaning unit 200, the accumulator 120 can increase the pressure of the solvent to keep the solvent in liquid form.

In some embodiments, the accumulator 120 can overpressure the solvent significantly above (e.g., at least about: 20% above, 35% above, 50% above, or more) a pressure required to maintain the solvent in liquid form. Certain implementations are configured such that when the valve 202 is opened, the solvent remains in liquid form despite the increase in volume.

Once liquid solvent is loaded within the cleaning unit 200, valve 202 can close. The solvent can be contained within the area defined by valves 202 and 208. The solvent here can flow between the apparatus 2000 and an agitation unit agitation unit 206.

As the solvent moves within the apparatus 2000, it can dislodge or otherwise remove contaminants from the apparatus 2000. The solvent can dislodge particulates stuck within the apparatus 2000, including but not limited to dust, particulates, solder or other components dislodged or misplaced during manufacturing of the apparatus 2000, grease, flux, and/or any other contaminants which could affect the accuracy and/or integrity of the apparatus 2000.

The agitation unit 206 can induce changes in pressure to the inside of the apparatus 2000 being cleaned. Various forms of agitation units can be utilized in the instrument cleaning system 1000. In some embodiments, more than one agitation unit can be used within the same instrument cleaning system 1000. In some embodiments, more than one agitation unit can be used within the same cleaning procedure.

In some embodiments, the agitation unit can comprise a pneumatic agitator (e.g., a pressure agitation unit) including a piston that moves within a piston housing. The pneumatic agitator can move the head of the piston within the housing to change the volume defined between valves 202 and 208; such fluctuation in volume in the closed system can induce movement of the solvent to clean the internal portions of the apparatus 2000.

In some embodiments, the cleaning unit 200 can comprise a cleaning sensor 204. The cleaning sensor 204 can be operatively connected to control operation of the agitation unit 206 in response to one or more characteristics sensed from the solvent. In some embodiments, the 204 can sense whether the fluid is in liquid form based on for example a measured pressure and a measured temperature, and issue corresponding instructions to the agitation unit 206 to make an appropriate change.

In some embodiments, a pneumatic agitator can draw the piston to lower the pressure exerted onto the solvent such that at least a portion of the solvent transitions to a gaseous state. This can be advantageous to manipulate the solvent within the apparatus 2000 to potentially reach areas where the solvent in a liquid state could not reach, such as for example and without limitation, around a large particulate within the internal components of the apparatus 2000. The agitation unit 206 can then extend the piston to increase the pressure exerted onto the solvent so that it returns to a liquid state, with the goal to dislodge or otherwise move or clean the internals of the apparatus 2000.

In some embodiments, the pneumatic agitator can be configured such that, when drawing a vacuum in the cleaning unit 200, the piston is drawn to its bottom dead center position such that volume within the cleaning unit 200 is minimized. This can advantageously reduce the number of molecules remaining within the evacuated cleaning unit 200, increasing the efficacy of any cleaning procedure performed. This can also lower the risk of over pressurization due to use of the hydraulic agitation system. In some embodiments, the piston is drawn to its top dead center position, such that volume within the cleaning unit 200 is minimized. The definition of a top dead center or a bottom dead center can vary based on relative orientation of the piston within the pneumatic agitator.

In some embodiments, the agitation unit 206 can comprise a mechanical agitator configured to physically manipulate the apparats with respect to the instrument cleaning system 1000. The mechanical agitator can manipulate the apparatus by rotating, vibrating, translating, or otherwise moving the apparatus 2000 relative to the instrument cleaning system 1000 to induce movement of the solvent within the internal portion of the apparatus 2000. For example, by rotating the apparatus 2000, a bubble or gas trapped within the apparatus 2000 can be manipulated out of the apparatus 2000, removing impurities. Vibrating the apparatus 2000 can similarly dislodge any solid particulates by inducing a turbulent flow pattern within the cleaned tool.

In some embodiments, the cleaning unit 200 can include a cooling or heating unit to change the temperature of the solvent. By cooling the solvent, lower pressure ranges may be needed to keep the fluid in liquid form. This may be necessary for an apparatus 2000 with a low maximum pressure, such as for a low pressure sensor. For example and without limitation, if the apparatus 2000 is a low pressure Bourdon tube (e.g., that has a maximum safe pressure of approximately 5 pounds per square inch), then the solvent cannot be pressurized above that pressure without harming the Bourdon tube; accordingly, the solvent can be cooled to approximately 0° Celsius to keep the solvent in liquid form without damaging the apparatus 2000. Advantageously, this allows the system to be used to clean delicate equipment, while still being able to use modernized cleaning solvents.

In some embodiments, the cleaning sensor 204 can further control operation of the agitation unit 206 to limit actuation so that the pressure of the solvent does not pressurize the solvent to or above the maximum safe pressure of the particular apparatus 2000. Rather, if the solvent is not in a liquid state at this maximum safe pressure, the cleaning unit 200 can cool the solvent to be in its liquid form.

Once the solvent is drawn into and out of the apparatus 2000 by the agitation unit 206, valve 208 can be opened to evacuate the solvent from the apparatus 2000. In some embodiments, the spent solvent can be examined by a user of the instrument cleaning system 1000 when the cleaning sampling valve 210 is opened, or be evacuated to a storage tank for distillation.

By opening cleaning sampling valve 210 or other inspection port, a user of the instrument cleaning system 1000 can inspect the spent solvent by dispensing a fixed amount into a sampling area 212 for examination. The spent solvent can be examined in a variety of ways to determine the particulates removed, and thus how clean the apparatus 2000 is by proxy. For example and without limitation, spent solvent can be examined using mass spectrometry testing, visual inspection, comparing the density of the waste solvent with the unused solvent, allowing the solvent to evaporate to review any depositions remaining, ion mobility spectrometry, gas chromatography sensors, and/or any other testing methods as desired or required for a particular solvent. In some embodiments, the type of test performed may vary based on the solvent used as well as the characteristics of the tools being cleaned.

In some embodiments, the cleaning sampling valve 210 can dispense a specific or predetermined amount of fluid for testing. In some embodiments, the cleaning sampling valve 210 can be configured to allow for bulk particulates to exit the instrument cleaning system 1000 for testing.

In some embodiments, inspection of the dispensed solvent in the sampling area 212 can automatically be analyzed by the instrument cleaning system 1000, the results of which can be displayed on a monitor or user interface for an operator to review. In some embodiments, if the instrument cleaning system 1000 determines that the spent solvent is not sufficiently clean, then the system can store the spent solvent for reprocessing and perform another cleaning operation. In some embodiments, inspection of the dispensed solvent in the sampling area 212 can be analyzed by an operator of the instrument cleaning system 1000.

If further cleaning procedures are required, the spent solvent can be drawn out from the cleaning unit 200 by a vacuum pump 216 to the distillation system 400, and a new vacuum can be drawn as described previously. This can be repeated as desired or required until the spent solvent is sufficiently clean. Once the apparatus 2000 is sufficiently clean, it can be separated from the instrument cleaning system 1000. The spent solvent can either be distilled concurrently or can be stored in a holding tank 402 within the distillation system 400 to await bulk processing.

Spent solvent can be pumped from the cleaning unit 200 to the distillation system 400 by vacuum pump 216 when distillation inlet valve 220 is opened. As the spent solvent moves through the conduit toward the vacuum pump 216, a filter 214 can remove any large particulates that could cause damage to the vacuum pump 216 or other components down the line. This filter 214 can be removable from the instrument cleaning system 1000 for cleaning and/or replacement, as desired or required. In some embodiments, the particular filter 214 used during a cleaning operation can be changed depending on the solvent used, the apparatus to be cleaned, and/or any other variations in the operation of the device, as desired or required.

### Distillation

Spent (e.g., used) solvent can be recycled by the distillation system 400 during or after a cleaning procedure for an apparatus 2000. Spent solvent can be stored for later distillation, or immediately processed during and/or immediately following a cleaning procedure.

Spent solvent can be drawn into the distillation system 400 by a distillation inlet valve 220. This spent solvent can be directed to either a holding tank 402 by opening valve 404, or towards the distillation tower 410 for immediate processing.

The holding tank 402 may be chilled and pressurized to keep the fluid in a liquid state. In some embodiments, spent solvent may be temporarily stored in the holding tank 402 to await batch processing within a distillation tower 410, rather than intermittently providing the distillation tower 410 with spent solvent after each cleaning procedure. However, in some embodiments, such as embodiments of the instrument cleaning system 1000 where continuous distillation occurs, a holding tank 402 may not be needed.

In some embodiments, spent solvent moving through the valve 406 toward the distillation tower 410 can be preheated by a heater 408 or heating element. By preheating the spent solvent enroute to the distillation tower 410, this can increase efficacy, efficiency, and/or distillation rate of the solvent within the distillation tower 410. The heater 408 can be controlled by a temperature sensor such that the fluid is heated sufficiently for a desired effect. In some embodiments, the pressure of the solvent entering the heater 408 can be approximately ambient pressure. This pressure can be controlled in part by the vacuum pump 216, by valves 220, 404, and 406, or by any pressurization mechanism within the holding tank 402.

In some embodiments, the heater 408 can heat the spent solvent to a temperature suitable for flash distillation upon entry into the distillation tower. Flash distillation can occur by heating the spent solvent approximately to the vaporization point of the solvent and quickly depositing this mixture into the distillation tower 410; upon entering the distillation tower 410, a large portion of the solvent may be immediately vaporized, leaving behind the waste product within the distillation tower 410 for removal. This temperature can vary based on the type of solvent used, the pressure of the solvent at this point, and the amount of contaminants present within the solvent. In some embodiments, this flash distillation point can occur when heating the solvent to approximately 20° Celsius.

In some embodiments, the spent solvent enters the distillation tower 410 by a nozzle on the inlet feed to encourage flash distillation. By dispersing the spent solvent into a mist and/or otherwise spreading the solvent upon entry into the distillation tower 410, the increased surface area of the spent solvent allows for quicker heating and distillation (e.g., vaporization) from the waste products.

The distillation tower 410 can include sensors and heating elements configured to heat the spent solvent mixture to its vaporization point (e.g., vaporization temperature, vaporization pressure, etc.). In some embodiments, the distillation tower 410 can operate at ambient pressure, which can lower the temperature needed to vaporize the solvent from the waste product. The spent solvent can be heated, causing the more volatile solvent to vaporize and separate from the waste product remaining. This vaporized solvent can rise through a series of condensation trays inside the column. As the vapor ascends, it can cool and condense on these trays, enriching the vapor phase in more volatile components and the liquid phase in less volatile ones, leading to a separation gradient along the height of the tower, where more pure solvent rises to the top of the distillation tower 410.

In some embodiments, the distillation tower 410 can be negatively pressurized. In some embodiments, the internal pressure of the distillation tower 410 is below 1 atmosphere. In some embodiments, the internal pressure of the distillation tower is approximately no more than 1 atmosphere. This can facilitate flow of the solvent through the system, and can decrease the temperature required to boil the volatile solvent from the waste product.

In some embodiments, the distilled solvent (e.g., clean solvent) is drawn from the distillation tower 410 as it passes through a valve 412, which can be a one-way check valve to reduce contamination. In some embodiments, the distilled solvent can then be cooled by a condenser 414 for temporary storage in a tank 418. In some embodiments, the condenser 414 can cool the distilled solvent to below about 18° Celsius to encourage liquidation of the distilled solvent. In some embodiments, the condenser 414 cools the solvent to below about 10° Celsius. In some embodiments, the condenser 414 cools the solvent to at least approximately 10° Celsius. In some embodiments, the reflux tank 418 can be chilled and/or pressurized to maintain the distilled solvent in a liquid form.

In some embodiments, flow through the distillation tower 410 can be increased through operation of a pump 416. Operation of the pump 416 can be controlled at last in part by the sensors controlling operation of the distillation tower 410.

In some embodiments, as the distillation tower 410 distills solvent from the spent solvent mixture, the temperature required for distillation may increase. This can decrease the efficiency and/or efficacy of the system, as by increasing the boiling temperature, volatile compounds from the waste product may be boiled and be mixed with the distilled solvent within the tank 418. Therefore, in some embodiments, the distillation tower 410 may additionally include a reflux system.

Refluxing at least a portion of the distilled solvent can increase the efficiency of a distillation tower, by enhancing the separation between components through repeated condensation and vaporization cycles. By returning a portion of the distilled solvent into the distillation tower 410, it can flow downward through the temperature gradient within the distillation tower 410 and interact with rising vapors. This interaction promotes better contact between phases, enriching the vapor with more of the solvent compounds while removing some of the waste contaminants. As a result, the concentration gradient between stages is sharpened, allowing for a purer distillate and more efficient separation within the distillation tower 410.

Distilled solvent from the reflux tank 418 can be reintroduced into the distillation tower 410 by opening reflux valve 420 and activating a reflux pump 424, drawing from the reflux tank 418. A one way check valve 422 can prevent any unwanted cross-contamination from the distillation tower 410.

The contaminants stored within the distillation tower 410 can be removed once the concentration between the contaminants and ay remaining solvent reaches a particular point. This can be determined in part by the temperature within the distillation tower 410; if the temperature has risen above or dramatically above an expected temperature for vaporization of the solvent at the pressure within the distillation tower 410, this can indicate that little if any solvent remains within the tower.

Waste can be removed from the distillation tower 410 by opening a valve 426 or similar system. A waste pump 427 can remove the waste product if it is in a semi-liquid state. Waste removed in this way can be disposed of by an operator of the system, or can automatically be disposed of by the instrument cleaning system 1000 itself.

In some embodiments, the distillation tower 410 may be run until the waste remaining is not sufficiently liquid to be drawn by a pump. Therefore, according to some embodiments, the distillation tower 410 can include a resealable opening to physically remove any waste product. This resealable opening can include a chute, a hatch, or any other mechanism designed to provide access to the waste portion of the distillation tower. In some embodiments, the waste hatch or other resealable opening can form an airtight seal with the distillation tower when closed.

Fluid can be routed from the tank 418 for inspection of its cleanliness. By opening valve 428 and activating a pump 430 (e.g. distillation pump, recirculation pump), fluid can be drawn from the reflux tank 418. In some embodiments, the distilled solvent can be drawn for storage in a distilled solvent tank 500, for inspection in a sampling area 434, or to return to the distillation tower 410 for further redistillation. This can allow for either an automatic or manual inspection of the distilled solvent to confirm its purity.

By opening distillation sampling valve 432, a user of the instrument cleaning system 1000 can inspect the distilled solvent by dispensing a fixed amount into a sampling area 434 for examination. The spent solvent can be examined in a variety of ways to determine the efficacy of the distillation system 400. For example and without limitation, the solvent can be inspected by mass spectrometry testing, visual inspection, comparing the density of the waste solvent with the unused solvent, allowing the solvent to evaporate to review any depositions remaining, ion mobility spectrometry, gas chromatography sensors, and/or any other testing methods as desired or required for a particular solvent. In some embodiments, the type of test performed may vary based on the solvent used, the characteristics of the tools being cleaned, and the expected waste product removed from the spent solvent. In some embodiments, comparisons between the waste product removed from the distillation tower 410 and the distilled solvent can be used to determine the type of contaminants which may be remaining within the distilled solvent.

In some embodiments, the distillation sampling valve 432 can be a two-way valve with an integrated check valve. In some embodiments, the distillation sampling valve 432 can be a standard valve. In some embodiments, the distillation sampling valve 432 can dispense a specific or predetermined amount of fluid for testing. In some embodiments, the distillation sampling valve 432 can be configured to allow for bulk particulates to exit the instrument cleaning system 1000 for testing.

In some embodiments, inspection of the dispensed solvent in the sampling area 434 can automatically be analyzed by the instrument cleaning system 1000, the results of which can be displayed on a monitor or user interface for an operator to review. In some embodiments, if the instrument cleaning system 1000 determines that the distilled solvent is not sufficiently clean, then the system can recirculate the distilled solvent for reprocessing by opening redistillation valve 436 and activate the distillation pump 430 to circulate the fluid back into the distillation tower 410. In some embodiments, inspection of the dispensed solvent in the sampling area 212 can be analyzed by an operator of the instrument cleaning system 1000.

In some embodiments, the distillation system 400 can include another heating element between the redistillation valve 436 and the distillation tower 410 to preheat the distilled solvent to its flash distillation temperature (e.g., vaporization temperature, vaporizing temperature, etc.). In some embodiments, the redistillation valve 436 can direct fluid into a preexisting heater 408 with a check valve to prevent backflow to bypass the distillation tower 410.

If further cleaning procedures are required, the spent solvent can be drawn out from the reflux tank 418 by the pump 430 to re-distill the distilled solvent. In some embodiments, the waste product can be removed from the distillation tower 410 before a supplemental distillation step is performed. This can be repeated as desired or required until the distilled solvent is sufficiently clean.

Fluid drawn from the reflux tank 418 can be observed by a sight glass 429 and/or measured by sensors positioned along the distilled solvent conduit. Inclusion of a sight glass could allow for manual confirmation that fluid is flowing through the distillation system 400 and the cleanliness of the fluid. The sensors could include a turbidity sensor, which can take measurements of the distilled solvent related to its cleanliness. This information can automatically allow for the instrument cleaning system 1000 to determine if further distillation processes are required.

If the solvent is sufficiently distilled, then a distillation outlet valve 438 can be opened and the distilled solvent can be drawn and/or pumped into a distilled solvent tank 500 for storage for eventual re-use in a cleaning procedure. In some embodiments, the distilled solvent can be pumped into the distilled solvent tank 500 by the distillation pump 430, which can pressurize the distilled solvent to a safe storage pressure. In some embodiments, this storage pressure is sufficient to maintain the solvent as a liquid when the distilled solvent tank 500 is at room temperature.

In some embodiments, the instrument cleaning system 1000 can include a plurality of distilled solvent tanks 500 to store distilled solvents. These distilled solvent tanks 500 can be filed sequentially such that solvent from different distillation runs are stored in different tanks. This can be advantageous as, as the solvent is repeatedly distilled, its purity may decrease over time as it picks up more and more chemicals which were not sufficiently removed by the distillation process.

In some embodiments, the distilled solvent tank(s) 500 can be pressurized and cooled so as to store the distilled solvent in a liquid state. In some embodiments, the distilled solvent tank 500 may maintain a lower temperature and/or pressure than the solvent supply tank 118. In some embodiments, the presence of contaminants within the distilled solvent may require these lower temperatures and pressures.

In some embodiments, the distilled solvent tank(s) 500 can pressurize the distilled solvent but remain at room temperature.

In some embodiments, the distilled solvent tank(s) 500 can be removed from the instrument cleaning system 1000 for storage and/or inspection, without depressurizing either the distilled solvent tank 500 or the instrument cleaning system 1000.

In some embodiments, the distilled solvent tank(s) 500 can be pressurized using accumulators similar to other accumulators disclosed herein, such as but not limited to an accumulator 120.

In some embodiments, sensors 502 can be positioned to be in fluid communication with the distilled solvent in the distilled solvent tank 500. These sensors can measure the pressure, temperature, physical state, and other characteristics of the distilled solvent. This information can be relayed to a control system designed to regulate the temperature and pressure of the distilled solvent tank 500. In some embodiments, the sensor 502 can monitor and display the pressure of the distilled solvent tank 500 to ensure proper storage of the distilled solvent and inhibit and/or prevent under-pressurization and/or over-pressurization.

In some embodiments, the distilled solvent can be pumped from the distilled solvent tank 500 into the solvent supply tank 118 for use in a cleaning procedure. The distilled solvent can be provided into a solvent supply tank 118 or a solvent supply tank 118 that contains some amount of solvent. The distilled solvent can assist in pressurizing the solvent supply tank 118 to an operable state. The distilled solvent can be provided in a pressurized form through use of a distilled solvent pump 504 and any accumulator in the distilled solvent tank 500 by opening distilled solvent valve 506 and closing valves 114 and 202.

In some embodiments, the distilled solvent can be pumped directly from the 500 to the cleaning unit 200 for use in a cleaning procedure. The distilled solvent can be provided in pressurized form through the use of a distilled solvent pump 504 and any accumulator in the distilled solvent tank 500 by opening distilled solvent valve 506 and closing valves 114 and 202 and any valve leading to the solvent supply tank 118. In some embodiments, if the solvent supply tank 118 is already pressurized with fluid provided by a solvent replenishment tank 110, then a valve to isolate the solvent supply tank 118 from the distilled solvent may not be necessary.

### Example Methods of Operation

Described herein are example methods for performing one or more operations of an embodiment of the instrument cleaning system 1000 described herein. These methods should be seen as examples of application of the concepts disclosed herein and should not be construed as any overly limiting requirements to be performed. One skilled in the art could understand that some steps can be performed out of sequence, or not at all, to achieve a similar or desired result.

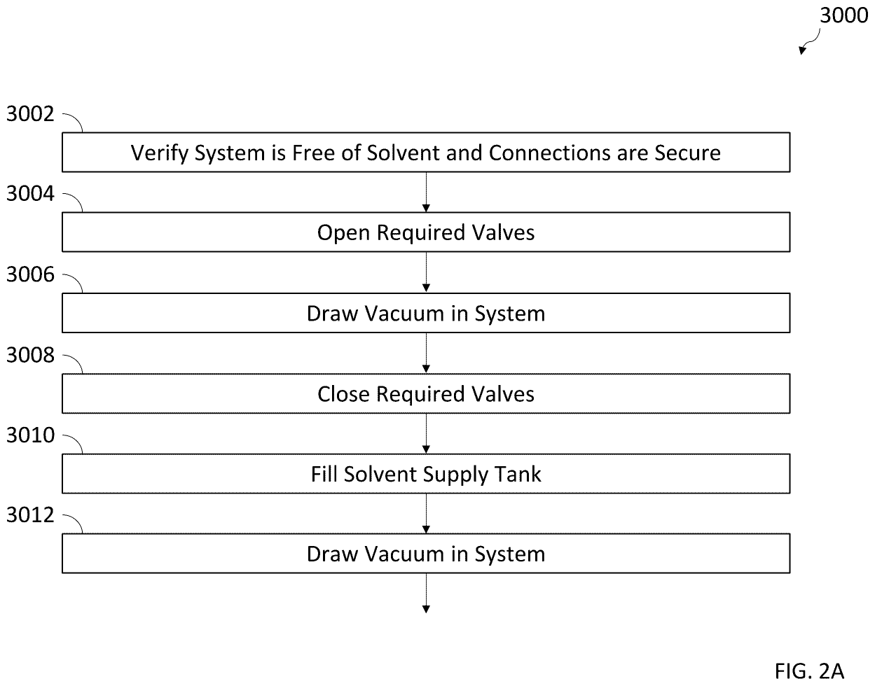

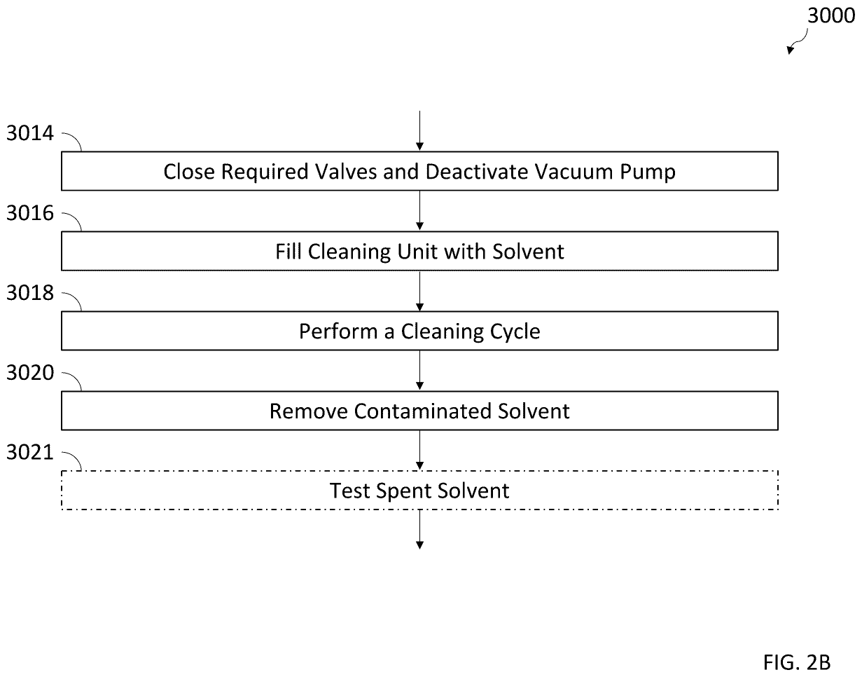

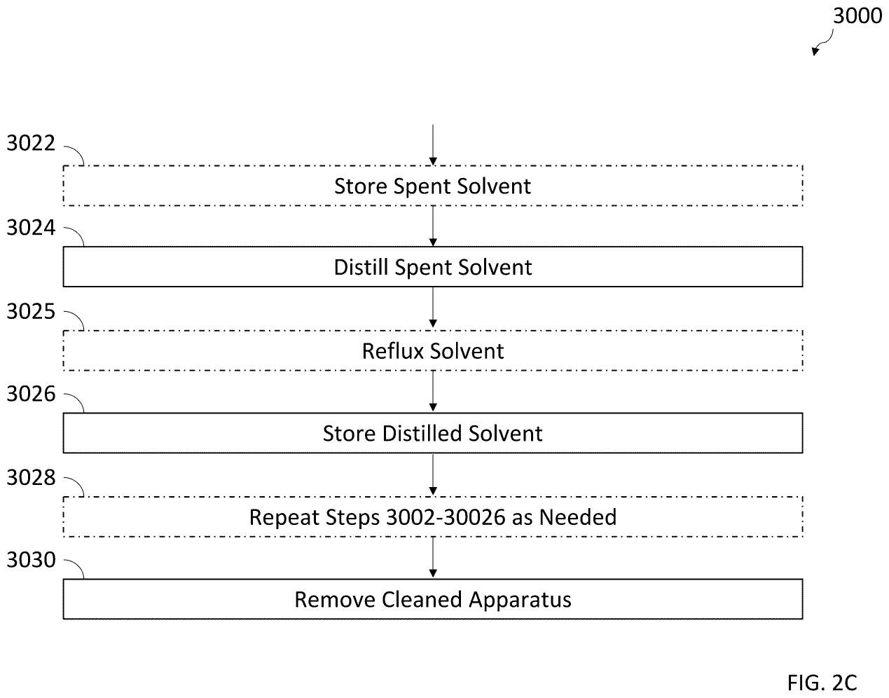

FIG. 2A-2C illustrate an example method 3000 of operation of an embodiment of the instrument cleaning system 1000 for cleaning an apparatus 2000 with solvent, and distilling said solvent for re-use in a later cleaning procedure. In certain implementations, some or all of the method is performed according to the order shown in the figures.

At step 3002, an operator of the instrument cleaning system 1000 can verify that conduits within the instrument cleaning system 1000 are free of solvent, that the instrument cleaning system 1000 is not under pressure, and that the solvent replenishment tank 110 and apparatus 2000 are connected to the system.

At step 3004, the operator and/or system can open some or all valves other than cleaning sampling valve 210, distillation inlet valve 220, valve 426, and distillation sampling valve 432.

At step 3006, vacuum pump 216 is activated do draw a vacuum within the instrument cleaning system 1000, until the vacuum reaches an appropriate level. Once appropriate vacuum is drawn, vacuum valve 218 can be closed.

At step 3008, valves 202, 208, 436, 438, and 506 are closed. If reflux refeed is not desired, close valve 420.

At step 3010, open the valve on the solvent replenishment tank 110, turn on pump 112, to fill the solvent supply tank 118. When a target volume, pressure, and temperature of the solvent is reached, close valve 114 and turn off pump 112.

At step 3012, open valve 208 and turn on vacuum pump 216 to draw a vacuum.

At step 3014, once a desired vacuum level is reached, close valve 208 and turn off vacuum pump 216.

At step 3016, open valve 202 to allow solvent into the cleaning unit 200. Once the pressure is stabilized to the desired level, close valve 202. The instrument cleaning system 1000 can be adapted (e.g., pressure and temperature controlled) such that the solvent in the UUT is in liquid form.

At step 3018, the agitation unit 206 is activated until a predetermined amount of time has elapsed or a cleaning cycle completes.

At step 3020, open valve 208 and activate vacuum pump 216 to remove the contaminated solvent from the cleaning system. The vacuum pump 216 can continue to pull vacuum until all solvent has been vaporized and removed and a sufficient vacuum level has been created.

At optional step 3021, one or more samples of the solvent can be expelled from the cleaning sampling valve 210 and tested for cleanliness.

The solvent then passes through distillation inlet valve 220 for distillation. The solvent travels either to the holding tank 402 by opening valve 404 and closing valve 406, or flows directly into the heater 408. Determining whether the solvent should be batch processed or immediately processed can depend on many things, such as customer selection, use case, and solvent type.

At optional step 3022, solvent is stored in the Contaminated Solvent Holding Tank 402, which can be designed to allow for batch distillation. This can typically be a slow process and may require a large holding tank. It may be bypassed or omitted from the system entirely to allow for continuous distillation which needs smaller hardware and a less powerful heater.

Continuous distillation can be performed immediately following a cleaning procedure but may require a continuous flow of solvent to create an equilibrium state in the distillation tower 410. A combination of these two may be appropriate in certain cases, or an “on demand” style of distillation may be used.

At step 3024, once leaving either the Contaminated Solvent Holding Tank or coming directly through distillation inlet valve 220, the fluid is heated by heating element 408 before being deposited into the distillation tower 410. Once in the distilling tower, the solvent will be heated until it vaporizes and then traveled upward past the check valve 412 and into the condenser 414 where it is cooled until it reaches its liquid form and drops into the reflux tank 418 where it is further cooled.

At optional step 3025, if the reflux refeed has been turned on, some liquid solvent will be pumped back into the tower by pump 424.

At step 3026, the distilled solvent is pumped by pump 430 out of the reflux tank and into the distilled solvent tank 500.

At optional step 3028, the fluid in the distilled solvent tank can be pumped into the supply solvent tank and the cycle can repeat.

At step 3030, when a desired level of cleanliness for the used solvent and/or apparatus 2000 has been achieved, the apparatus 2000 can be brought to ambient pressure (e.g., by opening outlet 219 with certain other valves closed, such as valves 202, 210, and 220). The UUT can be removed and a new UUT can be installed.

### Certain Language

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of the stated amount. As another example, in certain embodiments, the terms “generally parallel” and “substantially parallel” refer to a value, amount, or characteristic that departs from exactly parallel by less than or equal to 15 degrees.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### SUMMARY

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A system for cleaning internals of an apparatus using a solvent at a controlled temperature and pressure, the system comprising:
a supply tank configured to contain a solvent in liquid form;
a cleaning unit configured to receive an apparatus for a cleaning procedure, wherein the system regulates a temperature and a pressure of the solvent such that the solvent is provided in liquid form by a conduit to an internal portion of the apparatus;
an agitation unit within the cleaning unit, the agitation unit configured to agitate the solvent within the internal portion of the apparatus to remove a contaminant; and
a distillation system configured to distill the spent solvent drawn from the agitation unit for storage in a distilled solvent tank;
wherein, before the cleaning procedure, a vacuum is drawn in at least a portion of the system by one or more pumps, and
wherein the distilled solvent is suitable for use by the cleaning unit for the cleaning procedure.

2. The system of claim 1, wherein the supply tank further comprises a pressure source, the pressure source configured to maintain the solvent in liquid form when providing the solvent to the cleaning unit.

3. The system of claim 2, wherein the pressure source maintains the solvent at approximately 30 pounds per square inch gauge before providing the solvent to the cleaning unit.

4. The system of claim 2, wherein a sensor within the cleaning unit measures a pressure and a temperature of the solvent within the cleaning unit, wherein the pressure source is configured to pressurize the supply tank if the solvent is not in liquid form at the measured pressure and measured temperature to convert the solvent to liquid form.

5. The system of claim 1, wherein the system is configured to receive an input from an operator defining a safe pressure for the apparatus,
wherein the cleaning unit further comprises a sensor configured to measure a pressure and a temperature of the solvent within the cleaning unit, and
wherein the cleaning unit does not pressurize the solvent to or above the safe pressure for the apparatus while maintaining at least a portion of the solvent in liquid form by cooling the solvent.

6. The system of claim 5, wherein if the safe pressure is approximately 5 pounds per square inch, the solvent is cooled to approximately 0° Celsius.

7. The system of claim 1, wherein the agitation unit comprises a pneumatic agitator, the pneumatic agitator comprising a piston configured to move within a piston housing,
wherein the pneumatic agitator is configured to be filled with the solvent during the cleaning procedure, and
wherein a change in the volume of the pneumatic agitator induces movement in the solvent within the internal portion of the apparatus.

8. The system of claim 7, wherein the cleaning unit further comprises a pressure sensor, wherein operation of the pneumatic agitator is controlled based on readings from the pressure sensor.

9. The system of claim 7, wherein the pneumatic agitator is configured to fluctuate the pressure within the cleaning unit, wherein fluctuating the pressure forces at least a portion of the solvent into a gaseous state.

10. The system of claim 1, wherein the agitation unit comprises a mechanical agitator configured to manipulate the apparatus by rotating, vibrating, translating, or otherwise moving the apparatus relative to the system to induce movement of the solvent within the internal portion of the apparatus.

11. The system of claim 1, further comprising a filter positioned between the cleaning unit and the distillation system, the filter configured to collect solid particulates as the spent solvent moves toward the distillation system.

12. The system of claim 1, wherein the distillation system comprises:
a distillation tower configured to receive and separate the spent solvent into a waste product and the distilled solvent; and
a distillation tower configured to at least temporarily contain the distilled solvent;
wherein the distillation system removes contaminants from the spent solvent to create the distilled solvent.

13. The system of claim 12, further comprising a heating element configured to heat the spent solvent before the distillation tower to a temperature suitable for flash distillation.

14. The system of claim 12, further comprising a nozzle at an inlet to the distillation tower, wherein the spent solvent is misted and/or otherwise spread within the distillation tower, wherein misting the spent solvent increases the efficacy of flash distillation in the distillation tower.

15. The system of claim 12, wherein the distillation tower maintains an internal pressure of approximately no more than 1 atmosphere, and wherein the distillation tower is configured to heat the spent solvent to a vaporizing temperature when at the internal pressure.

16. The system of claim 12, wherein the distillation tower is configured to reflux at least a portion of the distilled solvent to the distillation tower, wherein refluxing to the distillation tower increases efficacy of the distillation system.

17. The system of claim 12, wherein the distillation system further comprises a condenser configured to condense the distilled solvent after the distillation tower.

18. The system of claim 1, wherein the distilled solvent tank is configured to store the distilled solvent, wherein a distillation pump pressurizes the distilled solvent tank to a storage pressure, wherein the storage pressure is sufficient to maintain the distilled solvent as a liquid when at room temperature.

19. The system of claim 1, further comprising a cleaning sampling valve positioned between the cleaning unit and the distillation system, the cleaning sampling valve configured to provide a sample of the spent solvent to a user for inspection to determine if further cleaning procedures are required.

20. The system of claim 1, further comprising a distillation sampling valve positioned between the distillation system and the distilled solvent tank, the distillation sampling valve configured to provide a sample of the distilled solvent to a user for inspection to determine if further distillation is required.
